(19) United States
(12) Patent Application Publication
(10) Pub. No.: US 2023/0072641 A1
(43) Pub. Date: Mar. 9, 2023

(54) Image Processing and Automatic Learning on Low Complexity Edge Apparatus and Methods of Operation

(71) Applicant: EAGLE EYE NETWORKS, INC., AUSTIN, TX (US)

(72) Inventors: Sankaranarayanan Parameswaran, Bangalore (IN); Shreejal Trivedi, Ahmedabad (IN); Clyde Bailey, Pune (IN); Anoop Kulangara Prabhu, Bengaluru (IN); Ashwini Kumar, Dist Ajmer (IN); Jagadeesh Dondeti, Sri Potti Sri Ramulu Nellore (District) (IN); Ranjith Parakkal, Bangalore (IN); Navaneethan Sundaramoorthy, Coimbatore (IN)

(21) Appl. No.: 17/470,188

(22) Filed: Sep. 9, 2021

(51) Int. Cl. G06K 9/00; G06N 20/00; G06K 9/62; G06K 9/68

(52) U.S. Cl. CPC G06K 9/00711; G06K 9/685; G06K 9/6262; G06N 20/00; G06K 2009/00738; G06K 2009/6871

(57) ABSTRACT

An edge device for image processing includes a series of linked components which can be independently optimized. A specialized change detector which optimizes the events collected at the expense of false positives is accompanied by a trainable module, which uses training feedback to reduce the false positives over time. A “look ahead module” peeks ahead in time and determines whether an inference pipeline needs to run. This allocates a definite amount of time for the validation and training module. The training module is operated in terms of a quantum of time. Processing time during phases of no scene activity is reserved to carry out training. A lightweight detector and the classifier are trainable modules. A site optimizer is made up of rules and sub-modules using spatio-temporal heuristics to handle specific false positives while optimally combining the change detector and inference module results.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### Technical Field

The disclosure relates to a system and method of training a machine learning module of an edge device for image processing and change detection.

### BACKGROUND

A variety of analytics problems involving structured input, e.g. cameras, are solved by running the input through machine learning models and using the inferences to report events or alerts. For example, the camera could be monitoring intrusion of people in a restricted area, and the model may trigger an event or alarm whenever a person enters the area. The cameras may be operational in sites with limited or no connectivity with the outside world. In such cases it may be necessary to run machine learning models on edge devices which are computing units having limited compute capability and memory.

Recent advances in machine learning algorithms have enabled powerful models that have high accuracy performance, but also are computationally intensive. Hence, while attempting to replicate performance of such high performance models on the edge devices, it becomes necessary on the one hand to reduce computational complexity of such models, resulting in drop in accuracy of performance metrics.

On the other hand, it can be appreciated by those skilled in the art that it is always possible to use a low computational complexity model to perform accurately in a restricted environment, while not being generalized well for all environments. It is now sufficient to have a small model that is well trained to the data from a specific site. But this presents a few challenges:
1. The required data needs to be extracted, automatically annotated and used for training. For example, it needs to avoid aggregating images having no activity, and pick meaningful images having activity.
2. There can be scenarios wherein the device may not be Internet-enabled, making it necessary to run the whole process on the device.
3. It is further possible that there may be insufficient data emanating from the site, making it hard to comprehensively train the model running on the device.
The above problems have motivated the inventions described in the following sections.

Heretofore, no known system or methods have addressed the question of performing machine learning and image processing in low performance edge devices with limited or no Internet connectivity.

### BRIEF SUMMARY

An edge device for image processing includes a series of linked components which can be independently optimized. A specialized change detector which optimizes the events collected at the expense of false positives is accompanied by a trainable module, which uses training feedback to reduce the false positives over time. A “look ahead module” peeks ahead in time and decides whether an inference pipeline needs to run or can be idled. This allocates a definite amount of time available for the validation and training module. The training module is operated in terms of a quantum of time units. Processing time during phases of no scene activity is reserved to carry out training. A lightweight detector and the classifier are trainable modules. A site optimizer is made up of rules and sub-modules using spatio-temporal heuristics to handle specific false positives while optimally combining the change detector and inference module results.

The invention described herein solves the dual problem of training on the edge while simultaneously maximizing the accuracy on the edge for the problem of interest using light-weight computational models and a series of linked components which can be independently optimized. In one embodiment of the invention, a specialized change detector optimizes the events collected at the expense of false positives. While it is well understood that change detector systems are highly prone to false positives, in this case, the change detector module is accompanied by a trainable module, which uses training feedback to reduce the false positives over time. In an embodiment of this invention, the inference unit consists of a universal light-weight detector and a classifier. The lightweight detector and the classifier are trainable modules. Training a classifier alone reduces the burden of the data as the classifier is trainable even in sites with limited data. Finally, a site optimizer offers a final layer of discrimination, and is made up of rules and sub-modules that are not dependent on the inference module.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide for: low cost and low performance edge apparatus with low connectivity performing narrow image processing tasks by machine learning. These and other features and advantages of the present invention will become apparent from the following detailed description of illustrative embodiments thereof, which is to be read in connection with the accompanying drawings.

### BRIEF DESCRIPTION OF THE SEVERAL VIEWS OF THE DRAWINGS

The foregoing and other objects, aspects, features, and advantages of the disclosure will become more apparent and better understood by referring to the following description taken in conjunction with the accompanying drawings, in which reference will be made to embodiments of the invention, example of which may be illustrated in the accompanying figure(s). These figure(s) are intended to be illustrative, not limiting. Although the invention is generally described in the context of these embodiments, it should be understood that it is not intended to limit the scope of the invention to these particular embodiments. Preferred embodiments of the present invention will be described below in more detail, with reference to the accompanying drawings:

FIG. 1 shows an overall system for image processing and automatic learning in a low complexity edge apparatus;

FIG. 2 shows a flow chart of a method embodiment of the invention;

FIG. 3 shows an inference unit according to an embodiment of present invention;

FIG. 4 shows a validation and training unit according to an embodiment of present invention;

FIG. 5 shows a storage unit of an edge device according to an embodiment of present invention;

FIG. 6 shows an exemplary computer system suitable for performance of the method steps; and

FIG. 7 shows a detailed embodiment of a Secondary Inference Module of a Verification and Training Unit.

### DETAILED DESCRIPTION

According to one or more embodiments of the present invention, a method of image processing includes a series of linked components which can be independently optimized. A specialized change detector which optimizes the events collected at the expense of false positives is accompanied by a trainable module, which uses training feedback to reduce the false positives over time. A “look ahead module” which peeks ahead in time and determines whether an inference unit needs to run. This allocates a definite amount of time for the validation and training module to run. The training module is operated in terms of a quantum of time units. Processing time during conditions of no scene activity is reserved to carry out training. A lightweight detector process and the classifier process are trainable modules. A site optimizer process performs rules and sub-modules using spatio-temporal heuristics to handle specific false positives while optimally combining the change detector and inference module results.

For purposes of clarity, the term “compute unit” is used below to refer to any compute device that performs inference, validation and training of machine learning modules and executes the series of steps covered in this invention. In one embodiment, the compute unit may refer to an embedded device running on the edge (networked with the on-site camera). In another embodiment, the compute unit may be a physical or virtual machine on the cloud. The scope of this invention covers both these scenarios, since it can be appreciated that having light-weight compute requirements (and thus lighter models) is beneficial on both the edge and cloud.

A system of training a machine learning module of a compute unit optimized to site conditions is described. The system accomplishes following sequence of operations:

1. Providing the input as a sequence of images from a camera, video stream, file server or any suitable medium which generates at least one video frame or image file.

2. Buffering the input by the change detection module, into a store of N frames. The value of N may be pre-determined or chosen according to site conditions. In one embodiment, the value of N is chosen based on the minimum time latency required for one iteration of training update. If this is 1 second, for example, the value of N is chosen to be 30 for an input that comes in at 30 frames per second.

3. Determining scene activity within the entire duration of the buffer. If all the N buffered frames do not have any activity, triggering to commence one iteration of training. In the presence of activity, training is disabled, and the inference module is enabled.

4. Performing inference processes time-shifted by N frames. Recording the outcome of this inference on storage medium. In particular, the various steps of this inference are:
a. A light-weight fixed detector (LD1) and light-weight trainable classifier (LC1) produce metadata of localized positions of detected objects of interest.
b. Producing by a heavy-weight trainable classifier (LC2) in parallel metadata of localized positions of detected objects of interest based on localizations derived from the change detector module.
c. Combining the outputs of steps a and b into a site-optimizer which combines the detections using several spatio-temporal parameters, which are weighted using a trainable neural network. The parameters are not only auto-trained using the on-device training, but also controlled using user-specified policies. In one embodiment, for an initial user-specified period, all weightage is given to weightage from the change detector, while no weightage is given to output of light-weight detector. After the initial on-device training, the site-optimizer is updated with learned parameters.
d. Recording the detections thus processed in the non-transitory media in a database format.

5. In case of a trigger given to the Validation-Training-Module (VTM) to perform validation/training (because of no activity in next N frames) a switch is made between one of the following 4 tasks:
a. Validating detections recorded in database and training data preparation.
b. Training iteration using prepared training data.
c. Testing of trained model using a test set.
d. Updating models of LC1, LC2 or site optimizer.

6. For step 5a, validating by a heavy model, the detections from the database. In one embodiment, the data thus annotated is appended directly to the training database. In another embodiment, the data thus annotated is reviewed by a human and then sent to a training database.

7. Sending the validation results to the Site-Optimizer to update the model weights. In one embodiment, the detection time, illuminance, position of detection, color histogram of detected object, size of detection are sent back to the site-optimizer, along with the results of the validator (true positive / false positive).

8. Step 5b is carried out whenever the database does not have new validation data (to exploit idle cycles of CPU), or when the amount of new training data exceeds a user-specified threshold. When certain pre-specified iteration of training are carried out, then instead of step 5b, step 5c is executed instead. In 5c, the trained model is validated against site-specific data (Va) and non-site-specific data (Vb). As long as accuracy of non-site-specific data (Vb) is above a user-specified threshold, the next training iteration is performed with Site-specific Training data (Ta), else with non-site specific Training data (Tb).

9. For each iteration of execution of 5c, recording the accuracy of site specific data (Va) in A[i]. A model update 5d is performed whenever A[i] > A[i-1] + T. Here T is a user specified minimum accuracy improvement required to justify model update through step 5d.

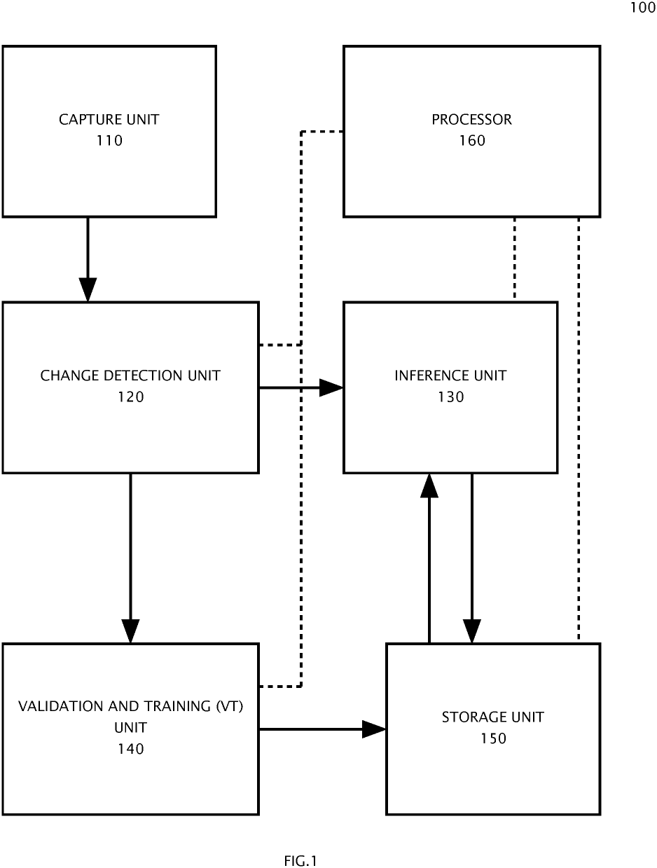

The FIG. 1 provides a high level description of the invention. The input images are fed through two pipelines, a simple change detection algorithm, which is effective but results in false positives, and a deep learning pipeline having two cascaded networks, the first network non-trainable and the second network being smaller and trainable. The results from both the arms of the pipeline go to a fuzzy decision box which considers various operational parameters to weigh its decision between the two arms. The resultant detections are designed to have slightly higher false positives but high recall. A heavier on-device or on-cloud model verifies the detections and creates a mock-up “ground truth”. This serves as input to the training model which updates the trainable networks in the system.

The invention may be distinguished from conventional systems by long sought solution to the following problems:
1. Training runs in parallel with the normal functionality of the device. As the change detection runs ahead of the pipeline, it allows early decision on whether the pipeline is likely to be idle and can be utilized for training.
2. The models are easily trainable, even with limited on-site data. The cascade detection architecture ensures this.
3. The site optimizer module is a stateful module ensuring best performance on site using the parallel arms, even surpassing performance of each individual arm. For example, during some time of the day, the precedence may be set higher for change detection.

Referring FIG. 1, system for training a machine learning module of an edge device is shown. Image or images are captured using any suitable camera, video stream, file server or any suitable medium which provides a constant stream of images 110. Images may be in the grayscale or color format. Image may be resized into the desired size by maintaining the aspect ratio. Image may be preprocessed. Obtained image is passed through a change or motion detection module 120. Change detection module works with continuous sequence of images. Change detection module identifies the disturbances in the scene by observing the visual characteristics of the scene. Scene is the area, which the camera monitors. Scene may have multiple cameras. Change detection module can be a background subtraction algorithm. Background subtraction algorithms may have few parameters, which have to be set by humans. Background subtraction algorithms may be modified algorithmically to handle the still objects in the scene. In another embodiment, change detection module can be a motion detection module. Motion detection module may work in a scene if there is any movement in the scene.

Background subtraction algorithm outputs the binary mask, which indicates the foreground and background regions. Foreground region may contain the newly entered objects into the scene or any moving objects within the scene. Binary mask may be used to say anything regarding the change observed in the scene. Standard deviation may be calculated over the obtained mask. Obtained standard deviation may be compared with a threshold value to say whether there is any change in the scene or not.

Motion detection module outputs a motion map. Motion map may be converted to a grayscale format. If there is no motion or disturbance in the scene, the motion map will be an empty one. Standard deviation may be calculated over the obtained map. Obtained standard deviation may be compared with a threshold value to say whether there is any change in the scene or not.

Irrespective of the change detection algorithm used, one of the common challenges is adjustments of user threshold specific to the scene to maximize positive detections while minimizing false alarms. This poses a challenge to any user as the user may have to set an optimal threshold to reduce false positives, but risking missing on true detections. This invention takes a slightly different strategy and the threshold parameters are set to maximize positive detections, irrespective of the number of false alarms.

When the Change detection module detects any change, inference unit 130 is invoked. Inference unit will be detailed later in the document. If the Change detection module does not detect any change continuously for a continuous sequence of frames (the number being configurable), a validation and training unit 140 may be invoked.. Inference unit 130 may always have higher priority over the validation and training (VT) unit 140. Outcome of the validation and training pipeline is mockup ground truths, which will be used for the training purposes. VT unit will output an updated model for the inference pipeline. The updated model may be chosen or not be chosen for inference purposes. Consideration of the updated model depends upon the performance obtained on the validation set.

When an image is determined to contain objects of interest, the image may be stored in the storage device 150. Along with the image, predictions of the inference model may be stored on the storage device. Predictions may have parameters such as coordinates of the detected objects, confidence of the predictions, timestamp of the image and site details. Storage unit 150 is also preloaded with the images, which contains the objects of interest, and the corresponding annotations. Preloaded images may be collected from different sites or from open source datasets.

Compute Units process the steps in one of a sequential manner and a parallel manner for inference unit. Few steps in the whole inference pipeline may be conditioned on some previous steps. Compute Units may be utilizing a significant Graphical Processing Unit or Processor and CPU memory available on the device during the inference time. As mentioned above, the pipeline may involve Machine Learning models, traditional computer vision algorithms and logic associated with the problem.

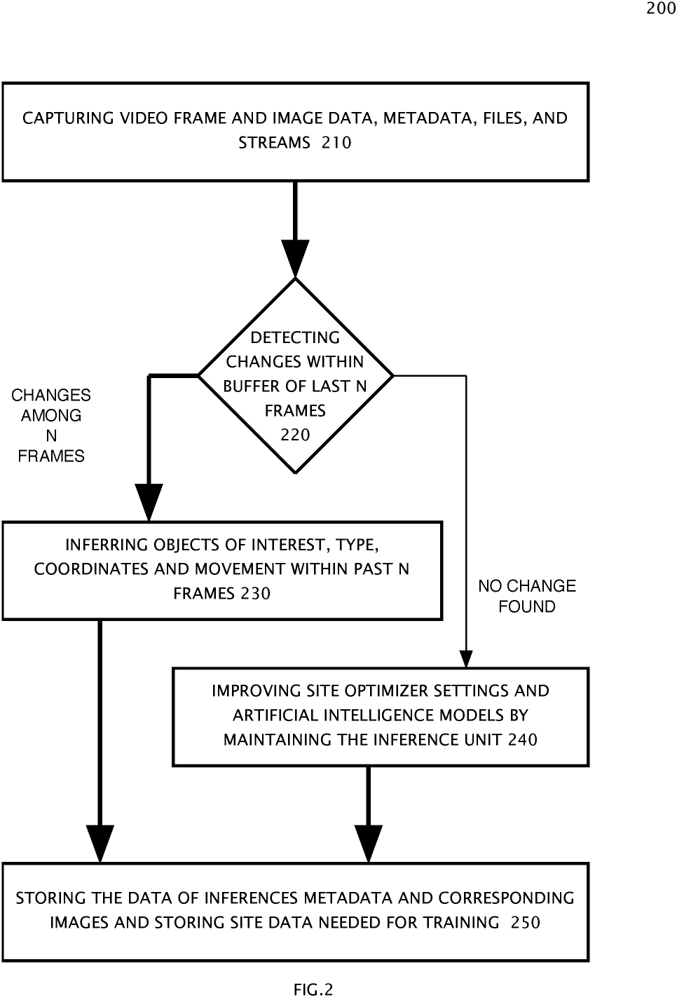

Referring to FIG. 2, a flow chart of a method embodiment of the invention is shown as an example of one aspect of the invention. The method includes: Capturing video frame and image data, metadata, files, and streams 210; Detecting changes within a buffer of N recent frames 220; when changes among n recent frames are detected, Inferring objects of interest, their type, coordinates, and movement within past N frames 230; when no changes found within the buffer, Improving site optimizer settings and artificial intelligence models by maintaining the inference unit 240; in either case, the method includes Storing the data of inferences metadata and corresponding images and storing site data needed for training 250.

When any change is observed in the scene, the inference unit 130 is invoked. Inference unit takes original image as an input. Inference unit utilizes two branches. One of the branches passes the input image to a change detection module. In one of the embodiments, Change detection module outputs the mask for the image. Change detection module outputs mask by looking at the previous images. When the inference unit is invoked, the first frame is considered as a background image. For the following continuous sequence of images, masks will be constructed on the basis of previous images. Blobs are constructed from the segmented masks. In another embodiment, change detection module outputs the motion maps. Blobs are reconstructed from the motion map using the variation of intensities in the map. All the blobs obtained from the change detection module may not be considered as prospects of the objects of interest. Considered blobs are sorted with respect to area. And very minute blobs may be eliminated from the list of sorted blobs. Only Top - K blobs from the sorted list of blobs may be considered for the next step. Here K is a parameter, which is set by humans. K is also limited by the compute power of the edge device. An image localizer module receives images from the change detection unit 120 and localizes area of change.

Blobs are passed through an Lightweight classifier for classifying the blobs as objects of interest or not. Lightweight classifier is a trainable parameter based algorithm. Lightweight classifier may have very low compute requirements. Lightweight classifier is learnt before using the site independent data. Site independent data contains objects of interest and other objects. Lightweight classifier outputs the probabilities of the blobs being an object of interest or not, using an Al model. Along with the probabilities, spatial parameters may be carried along with the probabilities for the next steps.

Original image is also passed through another branch of the inference pipeline. This branch consists of two parameter based algorithms. Initially, image is fed into an object detection module. Detector Module (DM) 1323 outputs the detection boxes for the objects of interest. All the detections may contain the objects of interest. Outputs from the Detector Module contain coordinates of the object, confidence associated with the prediction. All the outputs may be sorted with regard to the confidence. When the confidence of any of the outputs is falling below the threshold confidence, the box corresponding to the output may be flagged to pass through the Heavy weight First classifier module 1324. Heavy Weight First Classifier Module 1324 is pre-learnt using the open source and site independent data. When any of the outputs flagged for passing through the First classifier module 1324 is classified as an object of interest, then the image may be flagged for the consideration of the training process.

Results from both the branches are passed through a Site Optimizer module 1325. The site optimizer module takes as input a dictionary of past site specific ground truths, with additional information. It can be well appreciated by someone skilled in the art that the change detection module suffers from well-known problems, for example rustling trees can be raised as a false alarm. Similarly machine learning based detectors also may raise false alerts based on lighting conditions or unseen data. Based on the above, the site optimizer module captures the current operating parameters of the current detections. In one embodiment, the operating parameters can be the ambient light (as reported by camera), spatial position of detections, time of the day and size of detections. These parameters are flattened into a vector and a nearest neighbor algorithm is used to look up a dictionary and find the event that has the closest operating parameters. Based on this, the weightages to the change detection path and the machine learning detection paths are picked.

When the site optimizer determines that there is an object of interest in the scene, the image and the corresponding alert may be sent to a local or cloud dashboard. Image and alert information are stored in the storage unit 150 of the edge device. Alert information may contain information about the coordinates and confidence of the objects of interest and time stamp of the event. Stored images and alerts may be used for the training purposes. As mentioned before, when the change detection module does not observe any changes in the scene, training or validation pipeline is invoked. Validation pipeline may be invoked before the training pipeline to auto-annotate the inferred image. Inferred image, which was stored on the storage part of the device, is passed through an heavyweight machine learning algorithm, which is a parameter based algorithm. Heavyweight machine learning module 1324 may be a heavier variant of light weight machine learning algorithm, which is used in the inference pipeline.

Matching algorithm is based on Intersection over union ( IoU ) and Hungarian Algorithm. A threshold parameter for IoU is used for identifying the detections as False positives or True Negatives. After applying the IoU algorithm, when there are any false positives or true negatives, corresponding image is flagged for the human intervention. When there are no false positives or true negatives, human intervention may not be carried out.

In an embodiment, Human intervention is carried out without moving the data from the edge device. Data stored on the storage device is accessed through an local Application Programmable Interface (API) or cloud API. Inference results by the inference unit and auto annotations are provided through API along with the image data. Humans may intervene in the form of correcting existing annotations or drawing the annotations for the objects of interest. Human intervention may be or may not be carried out.

After the validation, training may be invoked for training the light weight machine learning. Preparation of training data is carried out for training the lightweight machine learning algorithm. Training data may be prepared from the preloaded data and data stored on the storage device after deployment of the edge device in the site. Ratio of the collected site specific data and the preloaded data i.e. from various sites and open source data, is a parameter set by humans and may be changed for obtaining better improvements during the training. Setting of site-specific parameters is carried out for the training pipeline. These parameters are learning rate, weight decay, number of iterations of training, frequency of validation and desired accuracy for a particular site. These parameters may be subjected to change during the course of deployment of edge devices at a particular site.

Advantageously, training is carried out on the edge device. Training does not happen continuously as priority between the validation training process and inference process is governed by the outputs of the change detection module. Training of the lightweight machine learning module 1322 helps in learning for the site by updating the parameters of the algorithm. Training involves both the forward and backward steps. Forward step involves propagating the image information through the network and calculation of loss of the outputs with respect to the ground truth. Backward step involves propagation of loss in the network. Updation of the parameters is carried out after all the images in a batch completed both the forward and backward steps. At regular intervals, the training unit may carry out validation on the images of the test set to obtain the accuracy on the test set and stores the parameters of the network to the storage device 150. Training process may happen indefinitely for continuous improvements. Best parameters obtained during the training process may be collected to a central server. In one of the embodiments, Lightweight Machine Learning in the Second Classifier Module 1322 may be trained using the training module. Outputs obtained from the validation module and images may be used in the training process. Best parameters may be chosen out of the stored parameters in the Model Parameter Database (MPD) 1503 for the inference purposes. Choosing of best parameters may be carried out by performing the validation on the Generic Training Dataset 1504 which contains images from the other sites and open source data and may contain images from the deployment site as well. Parameters for the inference pipeline are updated with the best parameters obtained from the training pipeline.

Analysis may be carried out on the results obtained from the inference pipeline with the help of the annotations obtained from the heavy model or human intervention. Trends may be observed on certain parameters like confidence value of the detections, IOU between the detections, which are given by the light weight model from the inference unit and the detections, which are given by the heavy model or the humans, False Positives and True Positives, Number of detections per class and Number of false positives per class etc.. All the previous mentioned parameters may be plotted with respect to time for a single day. Site wise statistics may be estimated by combining the day wise statistics for evaluating the overall performance of a model.

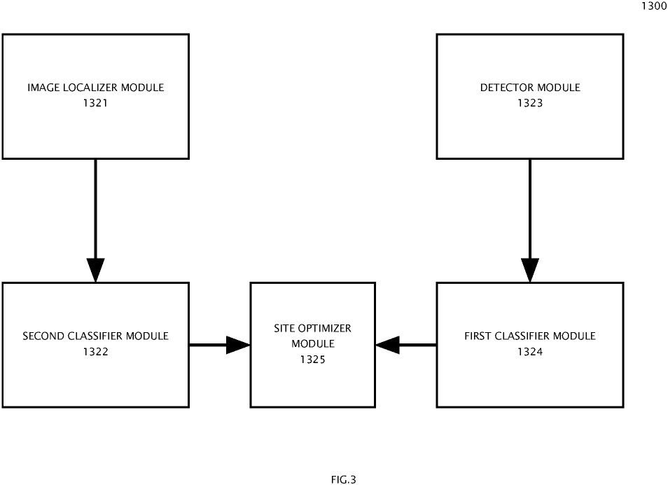

Referring to FIG. 3, the Inference Unit 1300 has a Site Optimizer Module 1325 fed from two sources, a First Classifier Module 1324, and a Second Classifier Module 1322. It performs inference on the N frames delayed data sent by the Change Detection Unit. The inferences are coordinates (bounding boxes) of objects of interest in the frame in addition to type of object.

An Image Localizer Module (ILM) 1321 receives images reported by the Change Detection Unit (120). In these images, it localizes area of change. This corresponds to the Light Weight and more error-prone channel. The Second Classifier Module (SCM) 1322 operates on the output of 1321. It crops out the localized area of change reported by 1321 and classifies this region as having an object of interest or not, using an Al model.

A Detector Module (DM) 1323 operates on the images reported by the Change Detection Unit (120). It uses an Al model and localizes the objects of interest. This corresponds to the Heavy Weight and computationally expensive channel. The First Classifier Module (FCM) 1324 operates on the output of 1323. It crops to the regions in image marked by 1323 and classifies them as having objects of interest or not, based on running an Al model.

The Site Optimizer Module (SOM) 1324 maintains a dictionary of objects, commonly seen in the site, with the information of whether they are objects of interest or not. It takes inputs from 1322 and 1324. Firstly for each object, it identifies whether it is reported by 1322 or 1324. Secondly it creates a feature based on time, coordinates within image and color distribution within object. Finally it marks the object as a positive or negative by referencing its dictionary of previously reported objects and finding closest match.

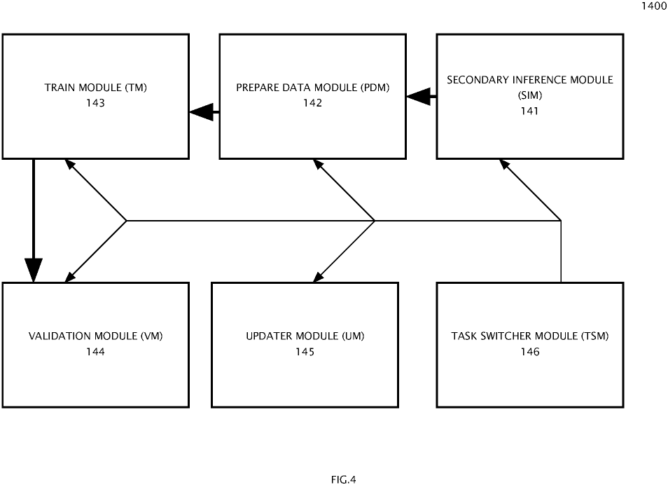

Referring to FIG. 4, The Validation and Training (VT) Unit 1400 is responsible for the overall maintenance and improvement of the Al models and site optimizer settings within Inference Unit (130). Each time the VTU is triggered, a Task Switcher Module (TSM) 146 decides which of the blocks 141 -145 needs to be executed. When triggered by the Task Switcher Module (TSM) 146, the Secondary Inference Module (SIM) 141 picks up images that have run by the Inference Unit (IU, 130) along with their annotations put in by the Inference Unit from the Storage Unit. It runs the inferences using a “bigger and more accurate” Al model, compares the produced annotations with that produced by Inference Unit and marks each image for suitability for training and places back into Storage Unit 150.

A Prepare Data Module (PDM) 142 prepares the dataset for training. This includes the images marked by 141 plus images that are not site specific and present in Storage Unit (150). Preparation of training data is carried out for training the lightweight machine learning. Training data may be prepared from the preloaded data and data stored on the storage device after deployment of the edge device in the site. Ratio of the collected site specific data and the preloaded data i.e. from various sites and open source data, is a parameter set by humans and may be changed for obtaining better improvements during the training.

A Train Module (TM) 143 runs an unspecified number of iterations of training using the data prepared by 142. Setting of site-specific parameters is carried out for the training pipeline. These parameters are learning rate, weight decay, number of iterations of training, frequency of validation and desired accuracy for a particular site. These parameters may be subjected to change during the course of deployment of edge devices at a particular site. Advantageously, training is carried out on the edge device. Training does not happen continuously as priority between the training pipeline and inference pipeline is governed by the outputs of the change detection module. Training of the lightweight machine learning module 1322 helps in learning for the site by updating the parameters of the algorithm.

Training involves both the forward and backward steps. Forward step involves propagating the image information through the network and calculation of loss of the outputs with respect to the ground truth. Backward step involves propagation of loss in the network. Updation of the parameters is carried out after all the images in a batch completed both the forward and backward steps. At regular intervals, the training pipeline may carry out validation on the images of the test set to obtain the accuracy on the test set and stores the parameters of the network to the storage device 150. Training process may happen indefinitely for continuous improvements. Best parameters obtained during the training process may be collected to a central server. In one of the embodiments, Lightweight Machine Learning in the Second Classifier Module 1322 may be trained using the training pipeline. Outputs obtained from the validation training unit 140 and images may be used in the training process. A Validation Module (VM) 144 runs validation on a dataset supplied by PDM 142, using the model produced by TM 143. An Updater Module (UM) 145 runs an update process wherein the latest model and a set of dictionary entries are updated onto the Inference Unit (IU) 130.

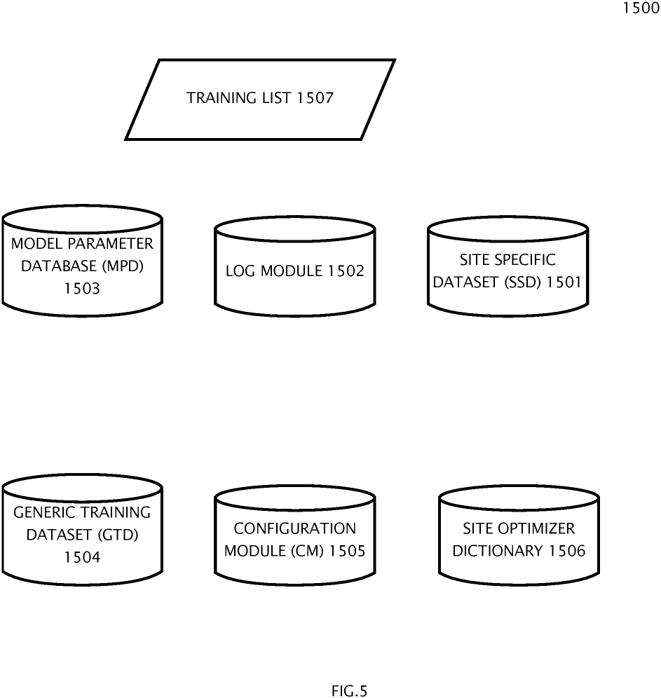

Referring to FIG. 5, a storage device of an edge device is shown. As shown, the storage unit 1500 of the edge device may contain information about the inferred images along with annotations produced by the Inference Unit in a Site Specific Dataset (SSD) 1501. Inferred images may be stored in a date wise manner. A Log Module 1502 records the monitoring information from all the modules. Logs contains runtime information about the training pipeline and the inference pipeline. Logs may be stored for the last few days. Deletion of logs occurs on the basis of Last in First Out LIFO principle. Top K best parameters of all the parameter based algorithms are maintained on the storage device. A Model Parameter Database (MPD) 1503 stores updated modules as produced by the Train Module 143. It includes updated modules for First Classifier Module (FCM) 1324, Secondary Classifier Module (SCM) 1322 and the Detector Module (DM) 1323. A Generic Training Dataset (GTD) 1504 contains data for training that is not site specific. Preloaded images contains images from the other sites and open source data and may contain images from the deployment site as well. A Configuration Module (CM) 1505 stores the configuration information that contains policies to decide accuracy requirements, data quantities for VTU, and time varying weightage policies for Site Optimizer Module. A Site Optimizer Dictionary 1506 stores the features for each detected object along with its ground truth (positive or negative) as returned by the Secondary Inference Module (SIM). A Training List 1507, is prepared by the Prepare Data Module (142), as it marks each incoming image to VTU as suitable for training or not.

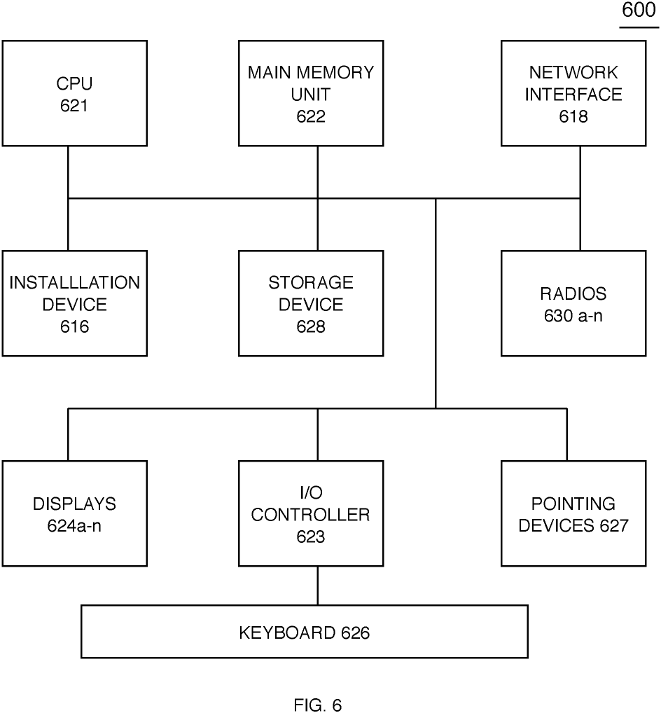

FIG. 6 is a block diagram of an exemplary computer system suitable for performance of the method embodiments. The blocks are further described below.

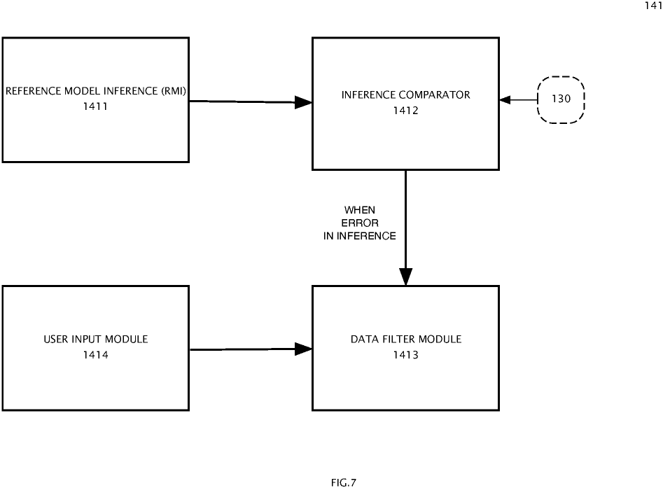

Referring to FIG. 7, an embodiment of one aspect of the Secondary Inference Module 141 is shown. This module is triggered by the Task Switcher Module (TSM 146). It picks up images that have run by the Inference Unit (IU, 130) along with their annotations put in by the Inference Unit from the Storage Unit. It runs the inferences using a “bigger and more accurate” Al model, compares the produced annotations with that produced by Inference Unit and marks each image for suitability for training and places back into Storage Unit 150. The Secondary Inference Module includes a Reference Model Inference, an Inference Comparator, a Data Filter Module, and in an embodiment, a User Input Module.

The Reference Model Inference (RMI) 1411 performs actual inferencing with a reference Al model that is more accurate but computationally slow.

The Inference Comparator 1412 compares the inference produced by 1411 with the inferences produced by the Inference Unit (130). The Data Filter Module 1413 selects the images where the Inference Unit (130) has inferencing errors, as determined by Inference Comparator (1412).

In an embodiment, the User Input Module 1414 takes additional User input to enhance the inference results of the Reference Model Inference (RMI). In an embodiment, Human intervention is carried out without moving the data from the edge device. Data stored on the storage unit is accessed through an local Application Programmable Interface (API) or cloud API. Inference results by the inference unit and auto annotations are provided through API along with the image data. Humans may intervene in the form of correcting existing annotations or drawing the annotations for the objects of interest. Human intervention may be or may not be carried out. This is optional to improve results and to resolve when automatic learning has deadlocked or is thrashing between sub-optimal solutions.

Building on the architecture of the system as disclosed above, one aspect of the invention is a method having the processes as follows: capturing an image, detecting an event in said image, on the condition the image contains an event, identifying the event, on the condition that no event occurs, performing validation and training, and storing the result of either identifying, validating, and training. The architecture enables incremental and independent optimization of the several components as resources come available during periods when no event is detected. Over time, a heavy Al machine learning classifier improves the quality of results specific to a site i.e. reducing false positives and false negatives by providing feedback to the lightweight classifier. The system automatically optimizes to avoid overtraining on site specific accuracy.

### Conclusion

The invention can be easily distinguished from conventional systems by allocating resources to training when no event is detected in real time i.e. video stream incoming to the buffer. The invention is easily distinguished from conventional systems by iterating validation to balance accuracy on a specific site with generality on other sites by remixing generic and site specific thresholds. Conventional system include centralized training and centralized machine learning which is unsuitable for intelligent edge devices. Conventional systems fail to iterate among site specific and generic event recognition for balanced performance.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.” Furthermore, it should be noted that any of the methods described herein can include an additional step of providing a computer system implementing a method for anomaly alarm consolidation. Further, a computer program product can include a tangible computer-readable recordable storage medium with code adapted to be executed to carry out one or more method steps described herein, including the provision of the system with the distinct software modules.

One or more embodiments of the invention, or elements thereof, can be implemented in the form of an apparatus including a memory and at least one processor that is coupled to the memory and operative to perform exemplary method steps. As is known, circuits disclosed above may be embodied by programmable logic, field programmable gate arrays, mask programmable gate arrays, standard cells, and computing devices limited by methods stored as instructions in non-transitory media.

Referring now to FIG. 6, generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, Global Positioning System (GPS), and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from Nvidia; those manufactured by or under license from Apple Computer; those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X0.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11 a, IEEE 802.11 b, IEEE 802.11 g, IEEE 802.11 n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS , manufactured by Microsoft Corporation of Redmond, Wash.; MAC OS and iOS, manufactured by Apple Inc., of Cupertino, Calif.; or any Linux or Unix operating system.

In some embodiments, the computing device 600 may have different processors, operating systems, and input devices consistent with the device. In other embodiments, the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View Calif. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment’, in another embodiment’, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for video surveillance, it will now become apparent to one of skill in the art that other embodiments incorporating the concepts of the disclosure may be used. Therefore, the disclosure should not be limited to certain embodiments, but rather should be limited only by the spirit and scope of the following claims.

As used herein, including the claims, a “server” includes a physical data processing system running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described.

The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user’s computing device to create a graphical user interface (GUI).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The foregoing description of the invention has been set merely to illustrate the invention and is not intended to be limiting. Since modifications of the disclosed embodiments incorporating the substance of the invention may occur to person skilled in the art, the claims below should be construed to include everything within the scope of the disclosure.

We claim:

1. A system of image processing and automatic learning comprises:
an image capturing unit for capturing an image of a site;
a change detection unit, connected to the image capturing unit, configured to process the image and identify any change in scene of the site, and enable one of
an inference unit; and
a validation training unit based change detection;
the inference unit, connected to change detection module, for identification of an event, and generating the notification when the change detection unit identifies change in the scene of the site;
the validation training unit, connected to the change detection unit, to perform validation and training when the change detection unit doesn’t identify any change in scene of the site; and
a storage unit, connected to the inference unit and the validation training unit, for storing the data received from the inference unit and the validation training unit.

2. The system of image processing and automatic learning as claimed in claim 1, wherein the inference unit comprises:
an event module, connected to the change detection module and the image capturing unit, configured to receive the image the from the image capturing unit and trigger from the change detection unit to process the image, and sending the notification based on identified event by the optimizer module; and
a processing module, which said processing module comprises:
an image localizer module configured to receive the image from the event module and determine the specific location of change and identifying the object in the image;
a second classifier module connected to the image localizer module for classifying the image based on identified object;
a detector module for receiving the image from the event module and processing the image to identify object in the image;
a first classifier module connected to the detector module for classifying the image based on identified object; and,
a site optimizer module for comparing the result of the image received from the first classifier module, and the second classifier module and based on site specific parameters to identify the appropriate event.

3. The system of image processing and automatic learning as claimed in claim 1, wherein the validation training unit comprises:
a validation module for validating the event identified by the inference unit, wherein the validation module comprises:
a machine learning module for identifying the event based on the processing image;
a comparing module for comparing the result of image processed from the machine learning module and the site optimizer of the inference unit;
an image train module for training the inference module in an event the compared result are not matched; and wherein the image train module is connected to
a user input module for receiving the input from the user for a specific image; and
a training module connected to the validation module for training the inference unit.

4. The system of image processing and automatic learning as claimed in claim 3, wherein the training module comprises:
a prepare data module for preparing the data for training the inference unit;
a site parameter module for setting site specific parameters;
a train module for training the inference unit;
a train validate module for validating whether the inference unit has been properly trained; and
a parameter updater module for updating a detector module, a first classifier module, the second classifier module, and the site optimizer of the inference module based on the training.

5. The system of image processing and automatic learning as claimed in claim 1, wherein the storage unit comprises:
a site specific image module,
a log module,
a parameter module,
an image module,
a configuration module, and
a site optimizer information module.

6. A system of image processing and automatic learning comprises:
an image capturing and change detection unit for capturing of an image of a site, and configured to process the image to identify any change in scene of the site, and enable one of
an inference unit; and
a validation training unit based change detection;
the inference unit, connected to change detection module, for identification of an event, and generating the notification when the change detection unit identifies change in the scene of the site; the validation training unit, connected to the change detection unit, to perform validation and training when the change detection unit doesn’t identify any change in scene of the site; and
a storage unit, connected to the inference unit and the validation training unit, for storing the data received from the inference unit and the validation training unit.

7. A method of image processing and automatic learning comprises:
capturing an image by an image capturing unit;
processing an image by a change detection unit to identify change in a scene of a site;
activating an inference unit by the change detection unit in an event change is detected by the change detection module;
activating a validation and training unit in an event no activity is detected by the change detection unit;
processing of the image by the inference unit to identify the activity in the captured image;
validating and training by the validation and training unit to train the inference unit; and
storing the data in the storage unit received by the inference unit and the validation training unit.

8. The method of image processing and automatic learning as claimed in claim 7 wherein the processing of an image by the inference unit comprises:
processing of image by an image localizer module to identify the object present in the image;
classifying the image by a second classifier module based on identified objects;
processing the image by the detector module to identify the object in the image;
classifying the image by the first classifier module based on object identified by the detector module;
comparing the result obtained from the first classifier module and the second classifier module by a optimizer module, and validating the same with its identified parameter; and
generating the notification based on result obtained from the result determined by the optimizer module.

9. The method of image processing and automatic learning as claimed in claim 7 wherein the step of validating and training by the validation and training unit to train the inference unit comprises:
processing of an image by a machine learning module;
comparing the predicted result of the image from the optimizer module of the inference unit, and the machine learning module,
when the result of the image of the optimizer module and the machine learning module are different, the image is sent for learning;
receiving input for an image to train the inference module; and
training the inference module by the training module.

10. The method of image processing and automatic learning as claimed in claim 9 wherein the step of training the inference module comprises:
preparing the data set for training using the prepare data module;
setting the site specific parameters to be applied for a specific site using a site parameter module;
training the detector module, the first classifier module, and the second classifier module by the train module;
performing the validation of trained module by the train validate module; and
storing the parameters and updating the parameters of the detector module, the first classifier module, and the second classifier module by the parameter module and the site optimizer module.
